(19) United States
(12) Patent Application Publication
(10) Pub. No.: US 2008/0192399 A1
(43) Pub. Date: Aug. 14, 2008

(54) Secondary battery apparatus and a protection circuit thereof

(76) Inventor: Sheng-Chung Chen, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/976,941

(22) Filed: Oct. 30, 2007

(30) Foreign Application Priority Data
Feb. 14, 2007 (TW) 96202835

(51) Int. Cl. H02H 3/08

(52) U.S. Cl. 361/115; 361/1

(57) ABSTRACT

A protection circuit is located in a secondary battery apparatus. The secondary battery apparatus includes a battery module and an input/output terminal. The protection circuit includes a first protection module, an electronic module, and a second protection module. The first protection module is coupled between the battery module and the input/output terminal. The first protection module is used to conduct on or cut off the circuit loop between the battery module and the input/output terminal. The electronic module is coupled with the battery module for monitoring the parameters of the battery module and controlling the first protection module to conduct on or cut off the circuit loop between the battery module and the input/output terminal. The second protection module is coupled with the electronic module for monitoring the operation current of the electronic module to conduct on or cut off the circuit loop of the electronic module.

### BACKGROUND OF THE INVENTION

1. Field of the Invention

The present invention relates to a secondary battery apparatus for the electronic device. In particular, this invention relates to a protection circuit of the secondary battery apparatus.

2. Description of the Related Art

As the information technology has been rapidly developed, the portable electronic device, including laptops, cell phones, PDAs etc, are popular in our daily life. Therefore, the power efficiency and the safety of the secondary battery apparatus that can be used as the power source of the portable electronic device are the important factors for the secondary battery apparatus. The secondary battery apparatus usually is packaged as a battery pack, and is installed in the electronic device for providing the power to the electronic device.

In order to guarantee the safety of the secondary battery apparatus, a protection circuit is located in the inner circuit of the secondary battery apparatus to detect the abnormal current and the voltage and turn off the circuit loop of the secondary battery apparatus when the loading is in short circuit, has a overloading current, or the secondary battery apparatus is abnormally charged or discharged. Thereby, the secondary battery apparatus is protected. Reference is made to FIG. 1, which shows a schematic diagram of the secondary battery apparatus of the prior art. The secondary battery apparatus 1 includes a battery module 11, an input/output terminal 13, and a protection circuit 10. The input/output terminal 13 includes two pins 131, 133. The pins 131, 133 are respectively coupled with the two poles (the positive pole and the negative pole) of the battery module 11 for inputting the charging power into the battery module 11 and outputting the power of the battery module 11.

In FIG. 1, the protection circuit 10 is coupled between the battery module 11 and the input/output terminal 13. The protection circuit 10 includes a protection module 15, an electronic module 17, and a fuse 19. The protection module 15 and the fuse 19 are respectively coupled between the battery module 11 and the input/output terminal 13 to make the circuit loop between the battery module 11 and the input/output terminal 13 be in ON-status or OFF-status. The electronic module 17 is coupled with the battery module 11 for monitoring the parameters of the battery module 11, including voltage, current, or temperature, etc. When the parameter of the battery module 11 is abnormal (such as excessively charged or discharged), the electronic module 17 controls the protection module 15 to cut off the circuit loop between the battery module 11 and the input/output terminal 13. The fuse 19 is coupled between the battery module 11 and the input/output terminal 13. When the current of the fuse 19 is larger than a predetermined value, the fuse 19 fuses to cut off the circuit loop between the battery module 11 and the input/output terminal 13 to assure the safety of the battery modul1 11.

Because the safety of the secondary battery apparatus is important for the user, how to enhance a safety mechanism of the protection circuit is a key topic for the designer. For example, Taiwan patents, TW 354861, TW 451508 and TW 1233228, disclose the protection circuits for the secondary battery apparatus. However, the circuit loop cut-off mechanism of the protection circuits is located between the battery module and the input/output terminal to prevent the battery module from being overheated, exploded and burnt down due to heavy current. When the electronic module is in a short-circuit status or an over-current status, the circuit loop cut-off mechanism of the prior art cannot cut off the related circuit loop and turn off the abnormal operation of the electronic components. Furthermore, when the circuit is in a short-circuit status or an over-current status, the electronic components in the electronic module may be overheated and burnt down so that the battery module is damaged. It is dangerous for the user.

### SUMMARY OF THE INVENTION

One particular aspect of the present invention is to provide a secondary battery apparatus, a protection circuit thereof, and an electronic device having the secondary battery apparatus. It uses a second protection module to monitor the operation current of the electronic module. When the current of the electronic module is overloaded, the circuit loop of the electronic module is cut off to prevent the electronic components in the electronic device from being overheated and burnt down due to the abnormal operation. Thereby, the safety of the secondary battery apparatus is assured.

The protection circuit is located in a secondary battery apparatus. The secondary battery apparatus includes a battery module and an input/output terminal. The protection circuit includes a first protection module, an electronic module, and a second protection module. The first protection module is coupled between the battery module and the input/output terminal. The first protection module is used to conduct on or cut off the circuit loop between the battery module and the input/output terminal. The electronic module is coupled with the battery module for monitoring the parameters of the battery module and controlling the first protection module to conduct on or cut off the circuit loop between the battery module and the input/output terminal. The second protection module is coupled with the electronic module. The second protection module monitors the operation current of the electronic module to conduct on or cut off the circuit loop of the electronic module.

The secondary battery apparatus includes a battery module, an input/output terminal, a first protection module, an electronic module, and a second protection module. The input/output terminal is used for inputting the charging power into the battery module, or outputting the power of the battery module. The first protection module is coupled between the battery module and the input/output terminal. The first protection module is used to conduct on or cut off the circuit loop between the battery module and the input/output terminal. The electronic module is coupled with the battery module for monitoring the parameters of the battery module and controlling the first protection module to conduct on or cut off the circuit loop between the battery module and the input/output terminal. The second protection module is coupled with the electronic module. The second protection module monitors the operation current of the electronic module to conduct on or cut off the circuit loop of the electronic module.

The present invention also discloses an electronic device. The electronic device has the secondary battery apparatus.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the secondary battery apparatus of the prior art;

FIG. 2 is a schematic diagram of the secondary battery apparatus of the present invention; and

FIG. 3 is a circuit diagram of the embodiment of the present invention.

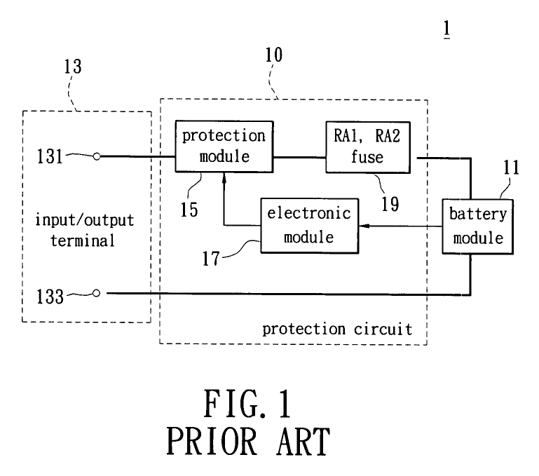

### DETAILED DESCRIPTION OF THE PREFERRED EMBODIMENTS

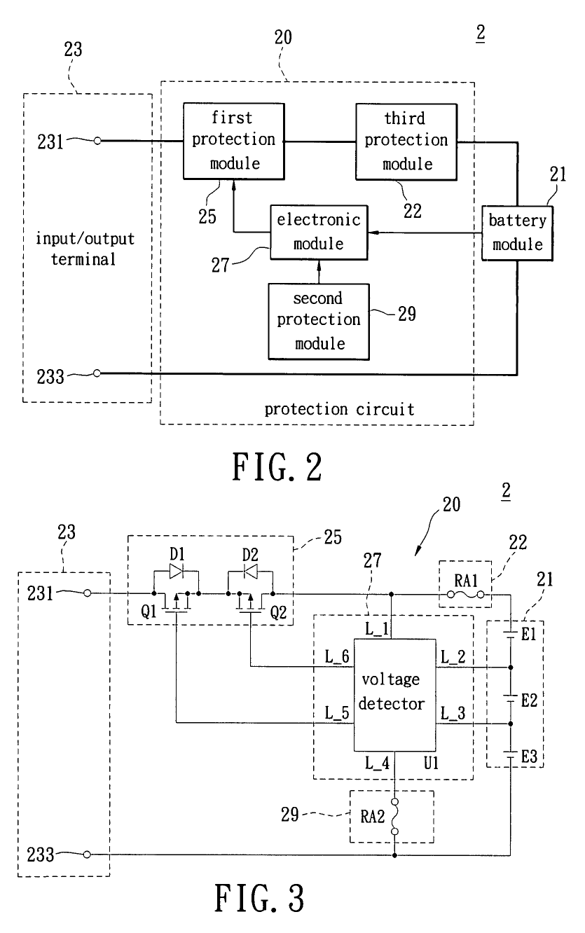

The prevent invention has a protection mechanism in the inner circuit of the secondary battery apparatus to enhance the safety of the secondary battery apparatus. Reference is made to FIG. 2, which shows a schematic diagram of the secondary battery apparatus 2 of the present invention. The secondary battery apparatus 2 has a battery module 21 and an input/output terminal 23. The secondary battery apparatus 2 is packaged as a battery pack, and is installed in the electronic device for providing the power to the electronic device. The battery module 21 includes at least one secondary battery that can be charged and discharged repeatedly. The input/output terminal 23 includes two pins 231, 233. The pins 231, 233 respectively coupled with the two poles (the positive pole and the negative pole) of the battery module 11 for inputting the charging power into the battery module 21 and outputting the power of the battery module 21 to the loading.

As shown in FIG. 2, in the secondary battery apparatus 2, there is a protection circuit 20. The protection circuit 20 is coupled between the battery module 21 and the input/output terminal 23 for cutting off the circuit loop to assure the safety of the secondary battery apparatus 2 when the current, voltage, or temperature in the secondary battery apparatus 2 is abnormal. The protection circuit 20 includes a first protection module 25, an electronic module 27, and a second protection module 29. The first protection module 25 is coupled between the battery module 21 and the input/output terminal 23. The first protection module 25 is used to conduct on or cut off the circuit loop between the battery module 21 and the input/output terminal 23. The electronic module 27 is coupled with the battery module 21. The electronic module 27 monitors the parameters of the battery module 21 (such as current, voltage, or temperature, etc) and controls the first protection module 25 to conduct on or cut off the circuit loop between the battery module 21 and the input/output terminal 23. The second protection module 29 is coupled with the electronic module 27. The second protection module 29 monitors the operation current of the electronic module 27 to conduct on or cut off the circuit loop of the electronic module 27.

Generally, the battery module 21 includes a plurality of battery units that are connected in serial. The electronic module 27 monitors the parameters (such as current, voltage, or temperature, etc) of each of the battery units and controls the first protection module 25 to cut off the circuit loop between the battery module 21 and the pin 231 when the parameters of the battery module 21 are abnormal (such as excessively charged or discharged). The electronic module 27 is composed of the sensor, the signal converting circuit and the control circuit. The monitoring mechanism is a prior art, and is not illustrated.

The first protection module 25 includes at least one control switch. The at least one control switch is coupled between the battery module 21 and the pin 231, and is controlled by the electronic module 27 to conduct on or cut off the circuit loop between the battery module 21 and the pin 231. The control switch is implemented by a field-effect transistor.

The second protection module 29 includes an over-current circuit-cutting element. The over-current circuit-cutting element is coupled in the circuit loop of the electronic module 27. When the operation current of the electronic module 27 is larger than a pre-determined current, the circuit loop of the electronic module 27 is cut off to prevent the electronic components from being abnormally operated. The over-current circuit-cutting element can be a fuse, and the rating current of the fuse matched with the operation current of the electronic module 27 so that the goal for protecting the electronic module 27 can be achieved.

In FIG. 2, the protection circuit 20 further includes a third protection module 22. The third protection module 22 is coupled between the battery module and the pin 231 of the input/output terminal 23. The third protection module 22 monitors the current of the circuit loop between the battery module 21 and the pin 231 to conduct on or cut off the circuit loop between the battery module 21 and the pin 231. Moreover, the third protection module 22 includes an over-current circuit-cutting element. The over-current circuit-cutting element is coupled between the battery module 21 and the pin 231. When the current flowing through the over-current circuit-cutting element is larger than a pre-determined current, the circuit loop between the battery module 21 and the pin 231. The over-current circuit-cutting element can be a fuse, and the rating current of the fuse matched with the operation current of the battery module 21 so that the goal for protecting the battery module 21 can be achieved.

Reference is made to FIG. 3, which shows a circuit diagram of the secondary battery apparatus 2 of the embodiment of the present invention. FIG. 3 is used for illustrating the basic concept of the present invention. As shown in FIG. 3, the battery module 21 includes three battery units E1, E2, E3. The electronic module 27 is implemented by a voltage detector U1. The first protection module 25 includes two field-effect transistors Q1, Q2, and two diodes D1, D2. The second protection module 29 and the third protection module 22 are respectively implemented by the fuses RA1, RA2. FIG. 3 displays the dominate circuit of the secondary battery apparatus 2. People skilled in this field know that there are still other electronic components and circuits not shown in FIG. 3 for achieving a variety of functions of the secondary battery apparatus 2.

In FIG. 3, the pin 231 is electrically coupled with the positive pole of the battery module 21 to form a positive pole circuit loop. The pin 233 is electrically coupled with the negative pole of the battery module 21 to form a negative pole circuit loop. The first protection module 25 and the third protection module 22 are located in the positive pole circuit loop. The fuse RA1 is coupled between the battery module 21 and the pin 231. When the current of the positive pole circuit loop is larger than a pre-determined current (that is related to the rating current of the fuse RA1), the fuse RA1 fuses to cut off the positive pole circuit loop for preventing the battery module 21 from being overheated and burnt down.

The transistors Q1, Q2 are respectively used as a control switch for the charging circuit and the discharging circuit of the battery module 21. The two diodes D1, D2 are respectively connected with the transistors Q1, Q2 in parallel for preventing the current from flowing inversely. The voltage detector U1 is an integrated circuit chip. In the voltage detector U1, there are a over-charge monitoring circuit and a over-discharge monitoring circuit for detecting the voltage of the battery units E1, E2, E3, and outputs a control signal to the transistors Q1, Q2 to conduct on or cut off the circuit loop between the battery module 21 and the pin 231 via the connecting pins L_5, L_6.

The electronic module 27 is coupled with the two poles of the battery module 21 to obtain the operation voltage and operate normally. As shown in FIG. 3, the connecting pins L_1, L_4 of the voltage detector U1 are respectively coupled with the positive pole circuit loop and the negative pole circuit loop. The fuse RA2 is coupled between the connecting pin L_4 and the negative pole circuit loop. When the operation current of the electronic module 27 is larger than a pre-determined current (that is related to the rating current of the fuse RA2), the fuse RA2 fuses to cut off the circuit loop between the connecting pin L_4 and the negative pole circuit loop and shut down the electronic module 27 for preventing the voltage detector U1 and the electronic components not shown in FIG. 3 from being burnt down due to the abnormal operation so that the electrolyte of the battery units E1, E2, E3 leaks, explodes and burns, and harms the user.

In additional to coupling between the connecting pin L_4 of the voltage detector U1 and the negative pole circuit loop, the fuse RA2 also can be located in the other location in the electronic circuit. In an embodiment, the fuse RA2 is coupled between the connecting pin L_1 of the voltage detector U1 and the positive pole circuit loop. The location of the fuse RA2 in FIG. 3 is an example, not used to limit the scope of the present invention.

The secondary battery apparatus, the protection circuit thereof, and the electronic device of the present invention uses a second protection module as a protection mechanism for the electronic module. When the current of the electronic module is overloaded, the second protection module cuts off the circuit loop of the electronic module to prevent the electronic components from being overheated and burnt down due to the abnormal operation. Thereby, the safety of the secondary battery apparatus is assured, and it is good for the user.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A protection circuit, located in a secondary battery apparatus, wherein the secondary battery apparatus includes a battery module and an input/output terminal, comprising:
a first protection module coupled between the battery module and the input/output terminal, wherein the first protection module is used to conduct on or cut off the circuit loop between the battery module and the input/output terminal;
an electronic module coupled with the battery module for monitoring the parameters of the battery module and controlling the first protection module to conduct on or cut off the circuit loop between the battery module and the input/output terminal; and
a second protection module coupled with the electronic module, wherein the second protection module monitors the operation current of the electronic module to conduct on or cut off the circuit loop of the electronic module.

2. The protection circuit as claimed in claim 1, wherein the second protection module includes an over-current circuit-cutting element, the over-current circuit-cutting element is coupled in the circuit loop of the electronic module, and the over-current circuit-cutting element cuts off the circuit loop of the electronic module when the operation current of the electronic module is larger than a pre-determined current.

3. The protection circuit as claimed in claim 2, wherein the over-current circuit-cutting element is a fuse.

4. The protection circuit as claimed in claim 2, wherein the battery module has two poles, and the electronic module is coupled with the two poles for operating normally.

5. The protection circuit as claimed in claim 4, wherein the over-current circuit-cutting element is coupled between the electronic module and one of the two poles.

6. The protection circuit as claimed in claim 4, wherein the two poles are a positive pole and a negative pole, and the over-current circuit-cutting element is coupled between the electronic module and the negative pole.

7. The protection circuit as claimed in claim 1, wherein the first protection module includes at least one control switch, and the control switch is coupled between the battery module and the input/output terminal to conduct on or cut off the circuit loop between the battery module and the input/output terminal.

8. The protection circuit as claimed in claim 7, wherein the control switch is a field-effect transistor.

9. The protection circuit as claimed in claim 1, further comprising a third protection module, wherein the third protection module monitors the current of the circuit loop between the battery module and the input/output terminal to conduct on or cut off the circuit loop between the battery module and the input/output terminal.

10. The protection circuit as claimed in claim 9, wherein the third protection module includes an over-current circuit-cutting element, the over-current circuit-cutting element is coupled between the battery module and the input/output terminal, and the over-current circuit-cutting element cuts off the circuit loop between the battery module and the input/output terminal when the current of the circuit loop between the battery module and the input/output terminal is larger than a pre-determined current.

11. The protection circuit as claimed in claim 10, wherein the over-current circuit-cutting element is a fuse.

12. A secondary battery apparatus, comprising
a battery module;
an input/output terminal for inputting the charging power into the battery module, or outputting the power of the battery module;
a first protection module coupled between the battery module and the input/output terminal, wherein the first protection module is used to conduct on or cut off the circuit loop between the battery module and the input/output terminal;
an electronic module coupled with the battery module for monitoring the parameters of the battery module and controlling the first protection module to conduct on or cut off the circuit loop between the battery module and the input/output terminal; and
a second protection module coupled with the electronic module, wherein the second protection module monitors the operation current of the electronic module to conduct on or cut off the circuit loop of the electronic module.

13. The secondary battery apparatus as claimed in claim 12, wherein the second protection module includes an over-current circuit-cutting element, the over-current circuit-cutting element is coupled in the circuit loop of the electronic module, and the over-current circuit-cutting element cuts off the circuit loop of the electronic module when the operation current of the electronic module is larger than a pre-determined current.

14. The secondary battery apparatus as claimed in claim 13, wherein the over-current circuit-cutting element is a fuse.

15. The secondary battery apparatus as claimed in claim 13, wherein the battery module has two poles, and the electronic module is coupled with the two poles for operating normally.

16. The secondary battery apparatus as claimed in claim 15, wherein the over-current circuit-cutting element is coupled between the electronic module and one of the two poles.

17. The secondary battery apparatus as claimed in claim 15, wherein the two poles are a positive pole and a negative pole, and the over-current circuit-cutting element is coupled between the electronic module and the negative pole.

18. The secondary battery apparatus as claimed in claim 12, wherein the first protection module includes at least one control switch, and the control switch is coupled between the battery module and the input/output terminal to conduct on or cut off the circuit loop between the battery module and the input/output terminal.

19. The secondary battery apparatus as claimed in claim 18, wherein the control switch is a field-effect transistor.

20. The secondary battery apparatus as claimed in claim 12, further comprising a third protection module, wherein the third protection module monitors the current of the circuit loop between the battery module and the input/output terminal to conduct on or cut off the circuit loop between the battery module and the input/output terminal.

21. The secondary battery apparatus as claimed in claim 20, wherein the third protection module includes an over-current circuit-cutting element, the over-current circuit-cutting element is coupled between the battery module and the input/output terminal, and the over-current circuit-cutting element cuts off the circuit loop between the battery module and the input/output terminal when the current of the circuit loop between the battery module and the input/output terminal is larger than a pre-determined current.

22. The secondary battery apparatus as claimed in claim 21, wherein the over-current circuit-cutting element is a fuse.

23. An electronic device having the secondary battery apparatus as claimed in claim 12.
